(19) United States
(12) Patent Application Publication
(10) Pub. No.: US 2020/0034178 A1
(43) Pub. Date: Jan. 30, 2020

(54) VIRTUALIZATION AGNOSTIC ORCHESTRATION IN A VIRTUAL COMPUTING SYSTEM

(71) Applicant: Nutanix, Inc., San Jose, CA (US)

(72) Inventors: Pranav Gupta, New Delhi (IN); Prerna Saxena, Bangalore (IN); Rabi Shanker Guha, Santa Clara, CA (US); Raghu Rapole, Telangana (IN)

(73) Assignee: Nutanix, Inc., San Jose, CA (US)

(21) Appl. No.: 16/049,595

(22) Filed: Jul. 30, 2018

(51) Int. Cl. G06F 9/455

(52) U.S. Cl. CPC G06F 9/45558; G06F 2009/45595; G06F 2009/45591

(57) ABSTRACT

A system and method for maintaining a virtual computing system in a desired state defined by a service definition includes parsing, by a health-check system of the virtual computing system, the service definition for identifying a component to which the service definition applies. The component is one of a virtual machine and a container of the virtual computing system. To maintain the desired state, the health-check system is configured to collect operating values of one or more parameters from the component, determine that the component is in violation of the service definition based on the operating values of the one or more parameters, and troubleshoot the component upon finding the violation for maintaining the virtual computing system in the state defined by the service definition.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently, with each virtual machine running an instance of an operating system. Virtual computing systems that include one or more containers in addition to the virtual machines are gaining popularity. Both containers and virtual machines utilize the hardware resources of the underlying host machine. However, unlike virtual machines, multiple containers share an instance of an operating system. Thus, modern virtual computing systems allow several operating systems and several software applications to be safely run at the same time on the virtual machines and the containers of a single host machine, thereby increasing resource utilization and performance efficiency. However, the present day virtual computing systems, particularly those virtual computing systems that have both virtual machines and containers thereon, have limitations due to their configuration and the way they operate.

### SUMMARY

In accordance with some aspects of the present disclosure, a method is disclosed. The method includes parsing, by a health-check system of a virtual computing system, a service definition for identifying a component to which the service definition applies. The component is one of a virtual machine and a container of the virtual computing system. The health-check system is configured to maintain the virtual computing system in a state defined by the service definition. The method also includes collecting, by the health-check system, operating values of one or more parameters from the component, determining, by the health-check system, that the component is in violation of the service definition based on the operating values of the one or more parameters, and troubleshooting, by the health-check system, the component upon finding the violation for maintaining the virtual computing system in the state defined by the service definition.

In accordance with some other aspects of the present disclosure, a system is disclosed. The system includes a health-check system associated with a virtual computing system having at least one virtual machine and at least one container. The health-check system includes a memory configured to store a service definition and a processing unit. The processing unit is configured to parse the service definition for identifying a component to which the service definition applies. The component is one of the at least one virtual machine and the at least one container. The health-check system is configured to maintain the virtual computing system in a state defined by the service definition. The processing unit is also configured to collect operating values of one or more parameters from the component, determine that the component is in violation of the service definition based on the operating values of the one or more parameters, and troubleshoot the component upon finding the violation for maintaining the virtual computing system in the state defined by the service definition.

In accordance with yet other aspects of the present disclosure, a non-transitory computer readable media with computer-executable instructions embodied thereon is disclosed. The instructions when executed by a processor of a health-check system associated with a virtual computing system cause the health-check system to perform a process. The process includes parsing a service definition for identifying a component to which the service definition applies. The component is one of a virtual machine and a container of the virtual computing system and the health-check system is configured to maintain the virtual computing system in a state defined by the service definition. The process also includes collecting operating values of one or more parameters from the component, determining that the component is in violation of the service definition based on the operating values of the one or more parameters, and troubleshooting the component upon finding the violation for maintaining the virtual computing system in the state defined by the service definition.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of a virtual computing system, in accordance with some embodiments of the present disclosure.

FIG. 2 is another example block diagram of the virtual computing system of FIG. 1, in accordance with some embodiments of the present disclosure.

FIG. 3 is an example block diagram of a node of the virtual computing system of FIGS. 1 and 2 showing a configuration of the virtual machines and containers on the node, in accordance with some embodiments of the present disclosure.

FIG. 4 is an example block diagram of a state monitoring system of the virtual computing system of FIGS. 1 and 2, in accordance with some embodiments of the present disclosure.

FIG. 5 is an example flowchart outlining a first set of operations performed by a task dispatcher of the state monitoring system of FIG. 4, in accordance with some embodiments of the present disclosure.

FIG. 6 is an example flowchart outlining operations performed by a scheduling service of the state monitoring system of FIG. 4, in accordance with some embodiments of the present disclosure.

FIG. 7 is an example flowchart outlining a second set of operations performed by the task dispatcher of the state monitoring system of FIG. 4, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a virtual computing system having a plurality of clusters, with each cluster having a plurality of nodes. Each of the plurality of nodes includes one or more virtual machines managed by an instance of a virtual machine monitor (e.g., hypervisor) and one or more containers managed by an instance of a container engine. These and other components of the virtual computing system may be part of a datacenter and may be managed by a user (e.g., an administrator or other authorized personnel) via a management system. To maintain the virtual machines and the containers in proper operational condition, the virtual machines and containers are regularly monitored. In other words, “health-checks” are regularly performed on containers and virtual machines to keep those components in top operating condition. By performing such health-checks, any problems and issues in the containers and virtual machines may be proactively identified and resolved.

However, since containers and virtual machines are configured differently and operate in different ways, containers and virtual machines have different monitoring requirements. Conventionally, containers and virtual machines are monitored using separate orchestration platforms. Container based orchestration platforms monitor containers and container based workflows only. Likewise, virtual machine based orchestration platforms monitor virtual machine and virtual machine based workflows only. The container and virtual machine orchestration platforms are not interchangeable and do not work together.

As virtual computing systems having both virtual machines and containers are gaining popularity, monitoring of those virtual machines and containers is becoming increasingly important and complex. Separate orchestration platforms for containers and virtual machines add to the complexity. Such separate orchestration platforms consume resources that may otherwise be delegated to and used by the containers and virtual machines. Thus, the performance of the containers and virtual machines is impacted.

Also, monitoring the containers and virtual machines separately is further complicated by the fact that the separate orchestration platforms are configured to monitor in different ways using different algorithms and different parameters. Each orchestration platform also requires a different state definition to maintain a desired state. To effectively maintain the virtual computing system having both virtual machines and container, an administrator desiring to maintain the virtual computing system in a particular operational state (e.g., desired state) is required to learn and operate two widely different orchestration platforms. For example, to maintain a desired state, the administrator is required to compile a state definition for monitoring containers that is in a format understood by the container orchestration platform. For the same desired state, the administrator is also required to compile a separate state definition for virtual machines that is in a format understood by the virtual machine orchestration platform. Thus, for one desired state, at least two separate state definitions are needed.

Thus, managing the virtual computing systems using separate orchestration platforms is not only inconvenient, it is confusing, inefficient, time consuming, and ultimately reduces the performance of the virtual computing system. Further, the maintenance and operation of two separate orchestration platforms requires the cost of installing, maintaining, and operating the two separate platforms.

Thus, the conventional mechanisms of monitoring virtual computing systems having coexisting virtual machines and containers are inadequate and prevent optimum operation. The present disclosure provides technical solutions. Specifically, the present disclosure provides improvements in computer related technology by which virtual machines and containers of a virtual computing system are homogenously managed and monitored by one orchestration platform. By managing the containers and virtual machines using a single orchestration platform, the virtual machines and containers can be easily monitored and health-checks performed using one set of requirements. The single orchestration platform is cheaper to install, operate, and maintain compared to the conventional separate orchestration platforms. By virtue of having to learn and operate a single orchestration platform, the administrator is able to more effectively and efficiently monitor the containers and virtual machines.

The single orchestration platform provides the same level of resiliency across both virtual machines and containers. Further, in contrast to the conventional platforms, the single orchestration platform provides a resiliency based on one desired state definition, rather than on separate state definitions, to uniformly maintain the virtual computing system in a desired state. Further, the single orchestration platform of the present disclosure provides an application based monitoring as well to maintain the virtual computing system in the desired state.

The orchestration platform of the present disclosure, thus, includes a health-check system that receives a service definition (e.g., state definition) from a user. The service definition defines the desired state of the virtual computing system. For example, in some embodiments, the service definition outlines the operating parameters based on which to monitor the containers and virtual machines of the virtual computing system. In some embodiments, the service definition may include separate monitoring requirements for containers and virtual machines. Thus, with a single service definition, both containers and virtual machines may be easily monitored.

The health-check system parses the service definition and monitors the operating values of the parameters identified in the service definition. Based on the operating values, the health-check system determines whether a container, a virtual machine, or an application thereon violates the service definition. Upon finding a violation, the health-check system takes corrective action to return the violating component back to the desired state, as described in greater detail below.

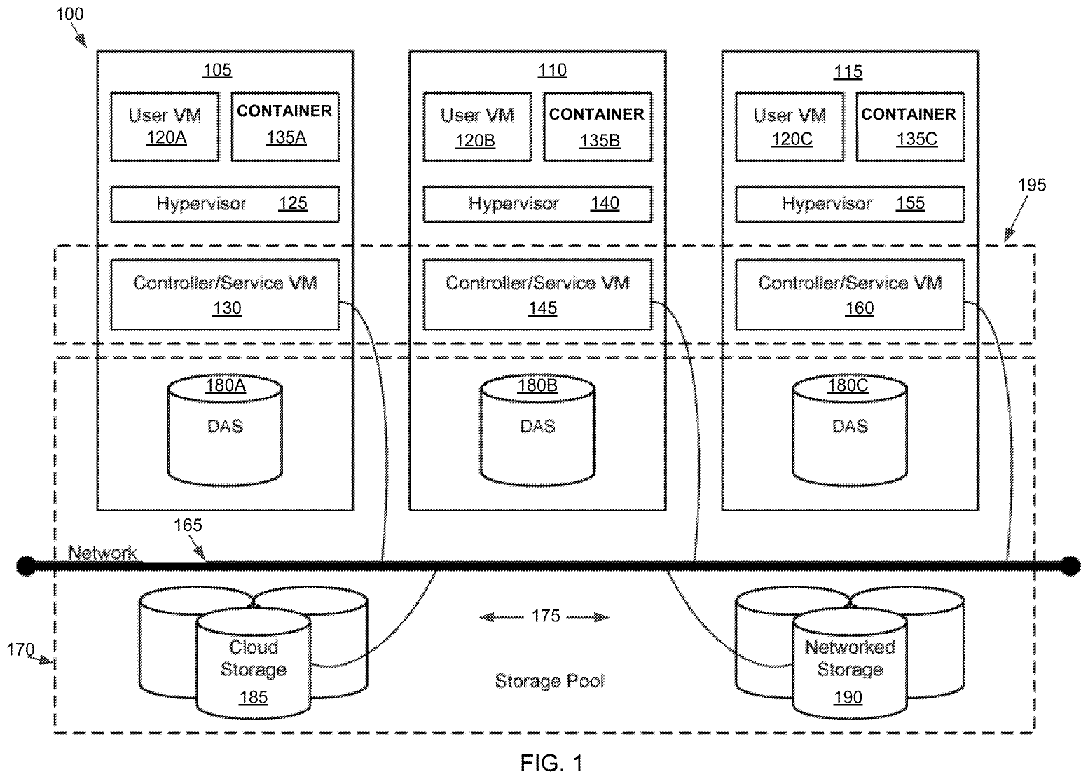

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 may also be referred to as a “host” or “host machine.” The first node 105 includes user virtual machine 120A, a hypervisor 125 configured to create and run the user virtual machines, a controller/service virtual machine 130 configured to manage, route, and otherwise handle workflow requests between the various nodes of the virtual computing system 100, and a container 135A. Similarly, the second node 110 includes user virtual machine 120B, a container 135B, a hypervisor 140, and a controller/service virtual machine 145, and the third node 115 includes user virtual machine 120C, a container 135C, a hypervisor 155, and a controller/service virtual machine 160. The controller/service virtual machine 130, the controller/service virtual machine 145, and the controller/service virtual machine 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 is accessible via the network 165 and, in some embodiments, may include cloud storage 185, as well as local storage area network 190. In contrast to the network-attached storage 175, which is accessible via the network 165, the direct-attached storage 180A, 180B, and 180C includes storage components that are provided internally within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system 100 to perform the functions described herein are contemplated and considered within the scope of the present disclosure.

Although three of the plurality of nodes (e.g., the first node 105, the second node 110, and the third node 115) are shown in the virtual computing system 100, in other embodiments, greater than or fewer than three nodes may be used. Likewise, although only a single instance of the user virtual machine 120A, 120B, and 120C and a single instance of the container 135A, 135B, and 135C is shown on each of the respective first node 105, the second node 110, and the third node 115, in other embodiments, the number of the user virtual machines and the number of containers on each of the first, second, and third nodes may vary to include additional user virtual machines and containers. The number of user virtual machines and the number of containers on each of the first node 105, the second node 110, and the third node 115 may be different.

In some embodiments, each of the first node 105, the second node 110, and the third node 115 may be a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service virtual machine 130, the controller/service virtual machine 145, and the controller/service virtual machine 160, and/or the hypervisor 125, the hypervisor 140, and the hypervisor 155. One or more of the first node 105, the second node 110, and the third node 115 may be organized in a variety of network topologies.

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (“ROM”) device and copy the instructions in an executable form to a temporary memory device that is generally some form of random access memory (“RAM”). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170, including the network-attached storage 175 and the direct-attached storage 180A, 180B, and 180C, together form a distributed storage system configured to be accessed by each of the first node 105, the second node 110, and the third node 115 via the network 165, the controller/service virtual machine 130, the controller/service virtual machine 145, the controller/service virtual machine 160, and/or the hypervisor 125, the hypervisor 140, and the hypervisor 155. In some embodiments, the various storage components in the storage pool 170 may be configured as virtual disks for access by the user virtual machines 120A, 120B, and 120C, and the containers 135A, 135B, 135C.

Each of the user virtual machines 120A-120C is a software-based implementation of a computing machine in the virtual computing system 100. The user virtual machines 120A-120C emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, into the underlying support for each of the user virtual machines 120A-120C that may run its own instance of an operating system and applications on the underlying physical resources just like a real computer. By encapsulating an entire machine, including CPU, memory, operating system, storage devices, and network devices, the user virtual machines 120A-120C are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user virtual machines 120A-120C, with each user virtual machine having its own guest operating system and sharing the resources of that one physical server computer, potentially across multiple environments. For example, each of the hypervisor 125, the hypervisor 140, and the hypervisor 155 may allocate memory and other resources to the underlying user virtual machines 120A-120C from the storage pool 170 to perform one or more functions.

By running the user virtual machines 120A-120C on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

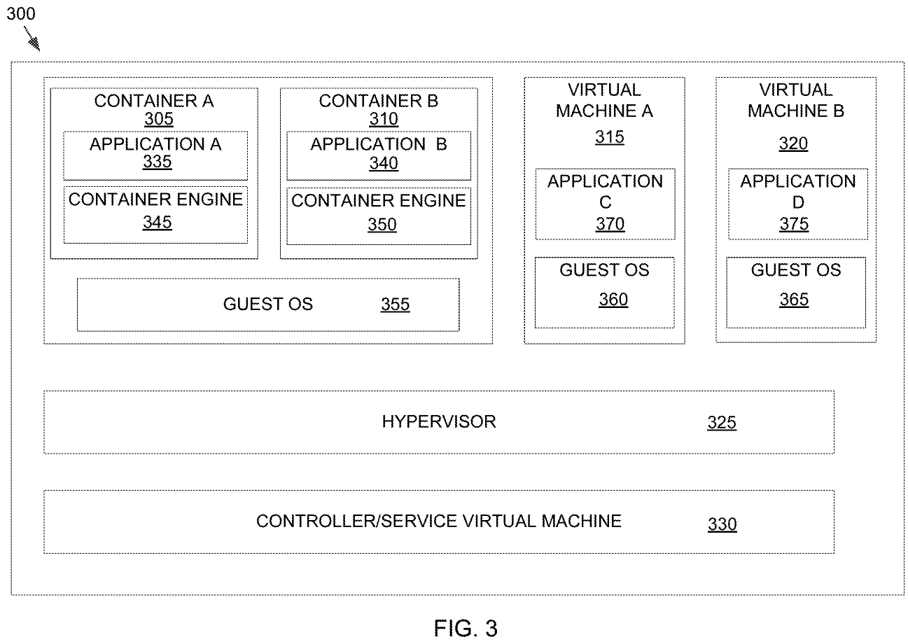

Similar to the user virtual machines 120A-120C, each of the containers 135A-135C is a software-based implementation of a computing machine. Unlike the user virtual machines 120A-120C in which each virtual machine has their own instance of the guest operating system, the containers 135A-135C share an instance of the guest operating system. Each of the containers 135A-135C is a stand-alone piece of software that encapsulates all application files and associated dependencies (e.g., software code, data, system tools and libraries, etc.) into one building block or package. Each of the containers 135A-135C may be managed by a container engine (not shown in FIG. 1). The configuration of the user virtual machines 120A-120C and the containers 135A-135C is described in greater detail in FIG. 3.

The user virtual machines 120A-120C and the containers 135A-135C are controlled and managed by their respective instance of the controller/service virtual machine 130, the controller/service virtual machine 145, and the controller/service virtual machine 160. The controller/service virtual machine 130, the controller/service virtual machine 145, and the controller/service virtual machine 160 are configured to communicate with each other via the network 165 to form a distributed system 195. Each of the controller/service virtual machine 130, the controller/service virtual machine 145, and the controller/service virtual machine 160 may also include a local management system (e.g., Prism Element from Nutanix, Inc.) configured to manage various tasks and operations within the virtual computing system 100. For example, in some embodiments, the local management system may perform various management related tasks on the user virtual machines 120A-120C and the containers 135A-135C.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc. The virtualization software on the hypervisor 125, the hypervisor 140, and the hypervisor 155 may be configured for running the user virtual machines 120, the user virtual machines 135, and the user virtual machines 150, respectively, and for managing the interactions between those user virtual machines and the underlying hardware of the first node 105, the second node 110, and the third node 115. In some embodiments, each of the hypervisor 125, the hypervisor 140, and the hypervisor 155 may also be configured to manage their respective instance(s) of the containers 135A-135C. In other embodiments, each of the containers 135A-135C may have its own instance of a managing device (e.g., a container engine) that is configured to manage the underlying container. Each of the controller/service virtual machine 130, the controller/service virtual machine 145, the controller/service virtual machine 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. For example, a particular user virtual machine (e.g., the user virtual machines 120A-120C) may direct an input/output request to the controller/service virtual machine (e.g., the controller/service virtual machine 130, the controller/service virtual machine 145, or the controller/service virtual machine 160, respectively) on the underlying node (e.g., the first node 105, the second node 110, or the third node 115, respectively). Upon receiving the input/output request, that controller/service virtual machine may direct the input/output request to the controller/service virtual machine (e.g., one of the controller/service virtual machine 130, the controller/service virtual machine 145, or the controller/service virtual machine 160) of the leader node. In some cases, the controller/service virtual machine that receives the input/output request may itself be on the leader node, in which case, the controller/service virtual machine does not transfer the request, but rather handles the request itself.

The controller/service virtual machine of the leader node may fulfil the input/output request (and/or request another component within the virtual computing system 100 to fulfil that request). Upon fulfilling the input/output request, the controller/service virtual machine of the leader node may send a response back to the controller/service virtual machine of the node from which the request was received, which in turn may pass the response to the user virtual machine that initiated the request. In a similar manner, the leader node may also be configured to receive and handle requests (e.g., user requests) from the containers 135A-135C and requests from outside of the virtual computing system 100. If the leader node fails, another leader node may be designated.

Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user virtual machines 120A-120C that are part of a cluster are configured to share resources of the cluster with each other. The containers 135A-135C may be configured to share resources of the cluster as well with each other. In some embodiments, multiple clusters may share resources with one another.

Additionally, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service virtual machine 130, the controller/service virtual machine 145, the controller/service virtual machine 160 for controlling the various clusters.

Again, it is to be understood again that only certain components and features of the virtual computing system 100 are shown and described herein. Nevertheless, other components and features that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

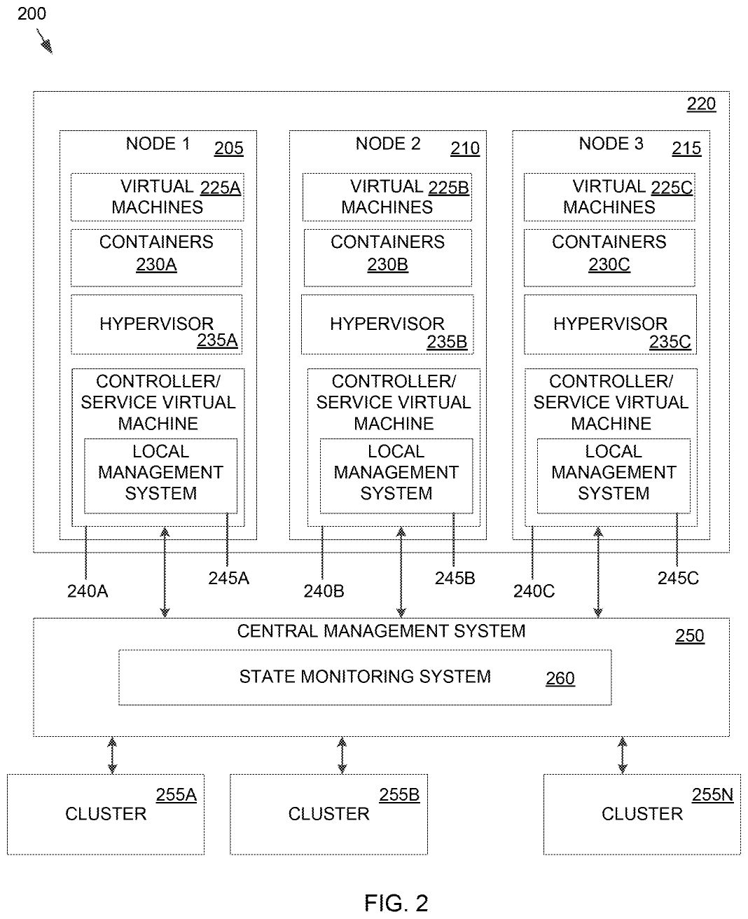

Turning to FIG. 2, another block diagram of a virtual computing system 200 is shown, in accordance with some embodiments of the present disclosure. The virtual computing system 200 is a simplified version of the virtual computing system 100, but shows additional details not specifically shown in FIG. 1. Although only some of the components have been shown in the virtual computing system 200, the virtual computing system 200 is intended to include other components and features, as discussed above with respect to the virtual computing system 100. As shown, the virtual computing system 200 includes a first node 205, a second node 210, and a third node 215, all of which form part of a cluster 220. Similar to the virtual computing system 100, although only three nodes (e.g., the first node 205, the second node 210, and the third node 215) have been shown in the cluster 220, the number of nodes may vary to be greater than or fewer than three.

The first node 205 includes virtual machines 225A, the second node 210 includes virtual machines 225B, and the third node 215 includes virtual machines 225C. The virtual machines 225A, 225B, and 225C are collectively referred to herein as “virtual machines 225.” The first node 205 also includes containers 230A, the second node 210 includes containers 230B, and the third node 215 includes containers 230C. The containers 230A, 230B, and 230C are collectively referred to herein as “containers 230.” Additionally, the first node 205 includes a hypervisor 235A and a controller/service virtual machine 240A. Similarly, the second node 210 includes a hypervisor 235B, and a controller/service virtual machine 240B, while the third node 215 includes a hypervisor 235C, and a controller/service virtual machine 240C. The hypervisor 235A, 235B, and 235C are collectively referred to herein as “hypervisor 235.” Similarly, the controller/service virtual machine 240A, 240B, and 240C are collectively referred to herein as “controller/service virtual machine 240.”

Further, each of the controller/service virtual machine 240A, controller/service virtual machine 240B, and controller/service virtual machine 240C respectively include a local management system 245A, a local management system 245B, and a local management system 245C. The local management system 245A, the local management system 245B, and the local management system 245C (collectively referred to herein as “local management system 245”), in some embodiments, is the Prism Element component from Nutanix, Inc., and may be configured to perform a variety of management tasks on the underlying node (e.g., the first node 205, the second node 210, and the third node 215, respectively).

The virtual computing system 200 also includes a central management system (also referred to herein as “overall management system”) 250. The central management system 250, in some embodiments, is the Prism Central component from Nutanix, Inc. that is configured to manage all of the clusters (e.g., including the cluster 220 and clusters 255A-255N) within the virtual computing system 200. In some embodiments, to manage a particular cluster (e.g., the cluster 220), the central management system 250 may communicate with one or more of the local management system 245 of that cluster. In other embodiments, the central management system 250 may communicate with the local management system 245 on the leader node or a local management system designated to communicate with the central management system, which in turn may then communicate with other components within the cluster (e.g., the cluster 220) to perform operations requested by the central management system. Similarly, the central management system 250 may communicate with the local management systems of the nodes of the clusters 255A-255N in the virtual computing system 200 for managing those clusters. The central management system 250 may also receive information from the various components of each cluster through the local management system 245. For example, the virtual machines 225 may transmit information to their underlying instance of the local management system 245, which may then transmit that information either directly to the central management system 250 or to the leader local management system, which may then transmit all of the collected information to the central management system.

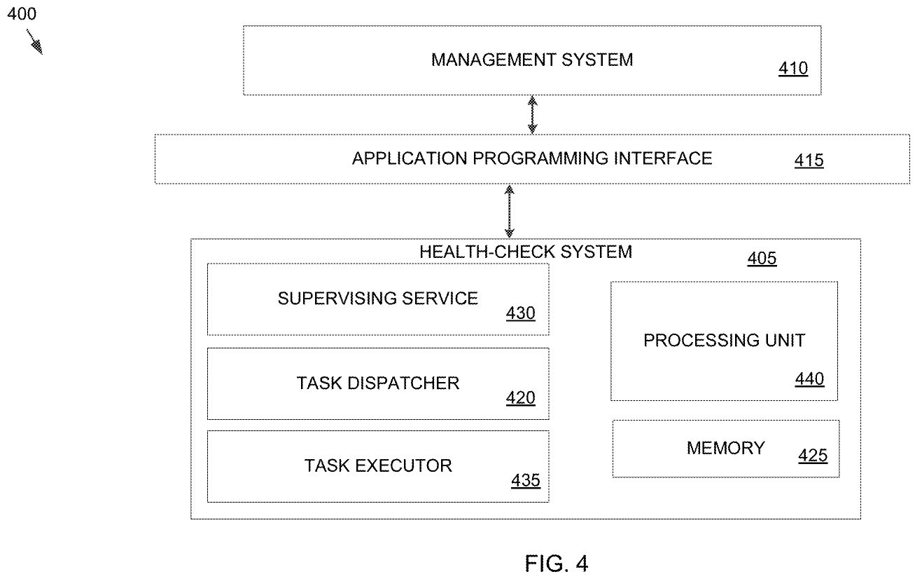

The central management system 250 also includes a state monitoring system 260. The state monitoring system 260 is configured to monitor certain operational aspects of the virtual machines 225 and the containers 230. Specifically, the state monitoring system 260 is configured to maintain the virtual computing system 200 in a desired operational state (also referred to herein as “desired state,” “desired state definition,” and the like). Specifically, the state monitoring system 260 provides an orchestration platform that attempts to maintain a desired state definition agnostic to either the virtual machines 225 or the containers 230. As indicated above, conventional mechanisms either monitor the virtual machines or the containers. The state monitoring system 260 provides a mechanism to monitor both the virtual machines 225 and the containers 230 regardless of the differences in configuration and operation of the user virtual machines and the containers. To maintain the desired state definition, the state monitoring system 260 performs health checks on the virtual machines 225, the containers 230, and at least some of the processes running on those user virtual machines and the containers, and takes corrective action when one or more of the virtual machines, the containers, or the processes running thereon fail a health check. The state monitoring system 260 is described in greater detail in FIG. 4.

Although the state monitoring system 260 has been shown as being part of the central management system 250, in some embodiments, the state monitoring system may be part of one or more of the local management system 245. In yet other embodiments, an instance of the state monitoring system 260 may be on the central management system 250 and another instance of the state monitoring system may be on one or more of the local management system 245. In some embodiments, certain features of the state monitoring system 260 may be made available on the central management system 250 and other features may be made available on one or more of the local management system 245. In some embodiments, the state monitoring system 260 or certain features of the state monitoring system may be located on one or more of the virtual machines 225, the containers 230, and/or within a process (e.g., user or system application) running on those virtual machines and the containers. In some embodiments, the state monitoring system 260 may be outside of but operatively associated with the virtual computing system 200. Thus, the state monitoring system 260 may be configured in a variety of ways.

Referring now to FIG. 3, an example block diagram of a node 300 is shown, in accordance with some embodiments of the present disclosure. The node 300 may be part of the virtual computing system 100 or 200 above. The node 300 is similar to the first node 105, the second node 110, the third node 115, the first node 205, the second node 210, and the third node 215. Further, the node 300 only shows certain elements. However, the node 300 may include other elements as described above with respect to the various nodes. As shown in FIG. 3, the node 300 includes containers 305 and 310, as well as virtual machines 315 and 320. Although only two containers (e.g., the containers 305 and 310) and two virtual machines (e.g., the virtual machines 315 and 320) are shown in FIG. 3, the number of containers and virtual machines may vary in other embodiments. The node 300 also includes a hypervisor 325 and the controller/service virtual machine 330. The hypervisor 325 and the controller/service virtual machine 330 are similar to the hypervisor and controller/service virtual machine described above. Likewise, the containers 305 and 310 are similar to the containers 135A, 135B, 135C, 230A, 230B, and 230C, while the virtual machines 315 and 320 are similar to the user virtual machines 120A, 120B, 120C, 225A, 225B, and 225C.

Each of the containers 305 and 310 is a stand-alone software that bundles all software code and related dependencies (e.g., system libraries, runtime tools, etc.) into one building block or package for running an application. For example, the container 305 may be configured for running an application 335, while the container 310 may be configured for running an application 340. While each of the containers 305 and 310 have been shown as being configured for running a single application (e.g., the applications 335 and 340), in other embodiments, either or both of those containers may run multiple applications. Further, although the applications 335 and 340 are shown as separate applications, in some embodiments, the containers 305 and 310 may be configured for collaboration such that both containers run the same application. The applications 335 and 340 may be any type of computer software. For example, in some embodiments, either or both of the applications 335 and 340 may be word processors, database programs, accounting programs, web browsers, multimedia programs, and any of a variety of software programs configured to manipulate text, numbers, graphics, or a combination thereof. In other words, the applications 335 and 340 may be any software that is designed for performing a group of coordinated functions or operations for an end-user. Either or both of the applications 335 and 340 may be web applications or mobile applications.

Each of the containers 305 and 310 also includes a container engine. For example, the container 305 includes a container engine 345 and the container 310 includes a container engine 350. The container engines 345 and 350 manage and facilitate operation of their respective underlying container. Each of the containers 305 and 310 share a guest operating system (“guest OS”) 355. The container engines 345 and 350 facilitate the sharing of the guest OS 355 between the containers 305 and 310.

By virtue of including all of the software and dependencies needed to run the applications 335 and 340, the containers 305 and 310, respectively, are able to isolate their respective applications from the surrounding environments, be portable between different environments without impacting the operations of the applications, and run on the same underlying infrastructure without impacting other containers. It is to be understood that only some components of the containers 305 and 310 are shown herein. Nevertheless, other components that are needed or desired for performing the operations described herein are contemplated and considered within the scope of the present disclosure.

The node 300 also includes the virtual machines 315 and 320. Unlike the containers 305 and 310 which share the guest OS 355, each of the virtual machines 315 and 320 has its own instance of a guest OS. For example, the virtual machine 315 operates on a guest OS 360, while the virtual machine 320 operates on a guest OS 365. Similar to the containers 305 and 310, each of the virtual machines 315 and 320 is configured for running an application. For example, the virtual machine 315 is configured for running an application 370, while the virtual machine 320 is configured for running an application 375. The applications 370 and 375 are similar to the applications 335 and 340. Specifically, the applications 370 and 375 are software programs configured for the benefit of and be used by an end user. Again, although single applications are shown, in other embodiments, either or both of the virtual machines 315 and 320 may run multiple applications. The virtual machines 315 and 320 are managed by the hypervisor 325. It is to be understood that only some components of the virtual machines 315 and 320 are shown and described herein. Nevertheless, other components that are needed or desired for performing the functions descried herein are contemplated and considered within the scope of the present disclosure.

Turning now to FIG. 4, an example block diagram of a state monitoring system 400 is shown, in accordance with some embodiments of the present disclosure. The state monitoring system 400 is discussed in conjunction with FIG. 3 above. The state monitoring system 400 may be considered utility software that is configured to monitor the containers 305 and 310, as well as the virtual machines 315 and 320 to maintain the virtual computing system of which the containers and virtual machines are part of in a desired state. Thus, the state monitoring system 400 is configured to monitor both the containers (e.g., the containers 305, 310) and the virtual machines (e.g., the virtual machines 315, 320). The state monitoring system 400 includes a health-check system 405 that is configured to receive a service definition from a user, monitor the containers 305 and 310, as well as the virtual machines 315 and 320 for violations of the service definition, and take corrective action upon detecting a violation for maintaining the virtual computing system (e.g., the virtual computing systems 100, 200) in compliance with the service definition. The health-check system 405 is communicably connected to a management system 410 via an application programming interface (“API”) 415. A user provides the service definition to the health-check system 405 and monitors/manages the health-check system via the management system 410.

The service definition based on which the health-check system 405 monitors the containers 305, 310 and the virtual machines 315, 320 defines the desired state of the virtual computing system (e.g., the virtual computing systems 100, 200). For example, the service definition may identify one or more operating parameters of the containers 305, 310 and/or the virtual machines 315, 320. The operating parameters may be metrics of processes (e.g., applications) that run a workload on the containers 305, 310 and/or the virtual machines 315, 320 on which to base health-checks on. Further, the service definition may include separate operating parameters to be monitored for the containers 305, 310, and separate operating parameters to be monitored for the virtual machines 315, 320. Based on the operating parameters being monitored, the service definition may provide monitoring at the virtualization layer (e.g., the container and virtual machine level), at the application layer (e.g., at the application level), or both.

For example, in some embodiments, at the virtualization layer, the service definition may include operating parameters such as network definitions to ensure that the containers 305, 310 and the virtual machines 315, 320 are accessible by external components (e.g., the end user, storage devices, hypervisor, and any other element attempting to establish communication with the container/virtual machine), replication number defining a number of times a container/virtual machine may be replicated (e.g., killed and restarted), storage definitions defining storage requirements to be maintained by a container/virtual machine. Storage requirements may define parameters such as the amount of active memory consumed by a container/virtual machine, limits on the types of memory compensating techniques (e.g., memory ballooning, memory swap, etc.) that may be used, etc. The service definition may also include processing capacity requirements, power requirements, CPU consumption parameters, operating system status parameters, and any other parameters that may be considered necessary or desired to monitor for ensuring a normal and proper operation of a container/virtual machine. At the application layer, the service definition may include, in addition to the parameters discussed above with respect to the virtualization layer, process based monitoring parameters that check the status of the underlying application, and other application specific end points.

In some embodiments, as indicated above, separate service definitions may be provided for containers and virtual machines. Further, in other embodiments, separate service definitions may also be provided for each application being monitored. Thus, depending upon the embodiment, a separate service definition may exist for a container, which monitors the container at the virtualization layer, and additional application layer one or more service definitions may exist for the applications being monitored on that container. Likewise, in some embodiments, a separate service definition may exist for a virtual machine, which monitors the virtual machine at the virtualization layer and additional one or more application layer service definitions may exist for the applications being monitored on that virtual machine. Thus, the service definition may be at the virtualization layer only (e.g., monitors the container/virtual machine and all applications thereon instead of specific applications), the application layer only (e.g., monitors specific applications only), and/or a combination of virtualization and application layers (e.g., monitors the container/virtual machine, and also monitors one or more specific applications thereon).

To identify the component (e.g., container, virtual machine, and/or specific application(s)) to which the service definition applies, the service definition may include an identity of the component to be monitored via that service definition. By parsing the service definition, the health-check system 405 determines whether the service definition is a virtualization layer definition, an application layer definition, or a combination of both. Specifically, the health-check system 405 determines whether the service definition applies to a container or a virtual machine, as well as the specific application(s) to be monitored. In addition to including the various operating parameters to monitor, the service definition also includes values of those operating parameters or other definition and thresholds of what constitutes a violation of those operating parameters. In other words, the service definition includes information for determining violations of the service definition.

Thus, the service definition may include information to identify the identity of the virtual machine or container, such as a base image of the virtual machine or container, the Internet Protocol (IP) address of the platform on which the virtual machine or container is deployed, any authentication information (e.g., username/password, keys, etc.) that may be needed to access the platform, number of instances of the virtual machine or container that need to be maintained to ensure high availability, an unavailability time period after which a new instance of the virtual machine or container is created as discussed below, number of CPUs required, amount of memory required, port on which the virtual machine or container service is running, name of the service that is running, ID of the new instance of the virtual machine or container to be created, and any other information that is needed or considered desirable. In other embodiments, different or other information may be defined within the service definition.

The health-check system 405 may request the user for a service definition upon deployment of a particular container or virtual machine. For example, when a new container or virtual machine is deployed or installed on a node, a task dispatcher 420 of the health-check system 405 associated with that node may send a request to the user requesting a service definition. The task dispatcher 420 may provide a service definition template to the user for the user to fill in the information and complete. Upon receiving the service definition template, the user may fill in the requested information, and transmit the completed service definition template back to the task dispatcher. The task dispatcher 420 may store the service definition template within a memory 425 of the health-check system 405. The information completed by the user within the service definition template constitutes the service definition. The task dispatcher 420 may periodically request the user to update the service definition. For example, in some embodiments, upon receiving indication that the component (e.g., container, virtual machine, application) associated with the service definition has been updated or reconfigured in some way, the task dispatcher 420 may retrieve the service definition template of that component from the memory 425, and transmit the service definition template to the user requesting updates. Upon receiving an updated version of the service definition template back from the user, the task dispatcher may save the updated version in the memory 425.

In some embodiments, the task dispatcher 420 may receive a service definition updating request from the user. The request may identify at least the component whose service definition is desired to be updated. Upon receiving the request, the task dispatcher 420 may retrieve the requested service definition template from the memory 425 and send the service definition template to the user. Upon receiving the updated service definition template from the user, the task dispatcher 420 may save the updated service definition template within the memory 425. Thus, the task dispatcher 420 is configured to request, receive, maintain, and update the service definition based on which the health-checks are performed by the state monitoring system 400.

In addition, the task dispatcher 420 is configured to parse the service definition. By parsing the service definition, the task dispatcher 420 converts the service definition into a form that is understood by a supervising service 430 that monitors the containers 305, 310 and the virtual machines 315, 320 for violations of the service definition. To parse the service definition, the task dispatcher 420 analyzes (e.g., reads) the information within the service definition template to identify various syntactic components and compiles the identified syntactic components in a form readily understood by the supervising service 430. The task dispatcher 420 may also create entities relevant to the realization of the service definition. Among other things, parsing the service definition decides whether the service definition corresponds to a container, a virtual machine, and/or a specific application. In other words, by parsing the service definition, the component to which the service definition applies may be identified. The parsed service definition also identifies the identity of the component to be monitored, as well as the operating parameters of the component to monitor. The task dispatcher 420 stores the parsed and compiled service definition within the memory 425.

The supervising service 430 determines violations of the service definition. To determine the violations, the supervising service 430 monitors the values of the operating parameters indicated within the service definition of the component being monitored. The supervising service 430 may monitor the parameters in a variety of ways. For example, in some embodiments, the supervising service may poll the component for values of the operating parameters being monitored. The supervising service may use an API to collect the values of the operating parameters. In other embodiments, the component may send information of those operating parameters to the supervising service 430 via the API or other mechansim. In yet other embodiments, the state monitoring system 400 (and/or the management system 410) may deploy software agents that are configured to collect values of the operating parameters being monitored. For example, in some embodiments, the agents may retrieve values of the operating parameters from operating system counters or other services, logs, or tools that collect information pertaining to those parameters being monitored and transmit to the supervising service 430. The supervising service 430, thus, collects operating parameter related information from multiple components and stores all of the collected information within the memory 425.

From the collected values of the operating parameters, the supervising service 430 identifies any violation of the service definitions. Upon identifying a violation, in some embodiments, the supervising service 430 attempts to repair and restart that component. In other words, the supervising service 430 attempts to troubleshoot the violation or take other corrective action. In some embodiments, the supervising service 430 may inform/alert the task dispatcher and the task dispatcher may take a corrective or troubleshooting action. In some embodiments, both the supervising service 430 and the task dispatcher 420 may take some corrective or troubleshooting action.

The task executor 435 is configured to communicate with the guest OS 355, 360, and 365 to maintain the containers 305, 310 and the virtual machines 315, 320 lifecycle.

Although the task dispatcher 420, the supervising service 430, and the task executor 435 are shown as separate components, in some embodiments, some or all of those components may be integrated together, and the integrated component may perform the functions of the separate components, as disclosed herein. Further, the health-check system 405, and particularly one or more of the task dispatcher 420, the supervising service 430, and the task executor 435 of the health-check system may be configured as hardware, software, firmware, or a combination thereof. Specifically, the health-check system 405 may include a processing unit 440 configured to execute instructions for implementing the task dispatcher 420, the supervising service 430, and the task executor 435, and the other functionalities of the health-check system 405. In some embodiments, each of the task dispatcher 420, the supervising service 430, and the task executor 435 may have their own separate instance of the processing unit 440. The processing unit 440 may be implemented in hardware, firmware, software, or any combination thereof “Executing an instruction” means that the processing unit 440 performs the operations called for by that instruction.

The processing unit 440 may retrieve a set of instructions from a memory for execution. For example, in some embodiments, the processing unit 440 may retrieve the instructions from a permanent memory device like a read only memory (ROM) device and copy the instructions in an executable form to a temporary memory device that is generally some form of random access memory (RAM). The ROM and RAM may both be part of the memory 425, which in turn may be provisioned from the storage pool 170 of FIG. 1 in some embodiments. In other embodiments, the memory 425 may be separate from the storage pool 170 or only portions of the memory 425 may be provisioned from the storage pool. In some embodiments, the memory in which the instructions are stored may be separately provisioned from the storage pool 170 and/or the memory 425. The processing unit 440 may be a special purpose computer, and include logic circuits, hardware circuits, etc. to carry out those instructions. The processing unit 440 may include a single stand-alone processing unit, or a plurality of processing units that use the same or different processing technology. The instructions may be written using one or more programming language, scripting language, assembly language, etc.

Referring still to FIG. 4, as indicated above, the health-check system 405 may be managed and operated by the management system 410. The user may provide the service definition also via the management system 410. The health-check system 405 may form the back-end of the state monitoring system 400, while the management system 410 may form the front-end of the state monitoring system. The user may, via the management system 410, instruct the health-check system 405 to perform one or more operations. Example operations may include providing new service definitions, updating existing service definitions, performing health-checks on demand, etc. Upon receiving instructions from the management system 410, the health-check system 405 may perform actions consistent with those instructions. Thus, the health-check system 405 is not visible to the user, but is rather configured to operate under control of the management system 410, which is visible to and operated by the user.

In some embodiments, the management system 410 may be installed on a device associated with the central management system (e.g., the central management system 250) and/or the local management system (e.g., the local management system 245). In some embodiments, the management system 410 may be accessed physically from the device on which the state monitoring system 400 (and particularly the health-check system 405) is installed. In other embodiments, the state monitoring system 400 and the management system 410 may be installed on separate devices. Further, the management system 410 may be configured to access the health-check system 405 via the API 415. The API 415 may be separate and different from the API used to facilitate collection of the values of the operating parameters via the supervising service 430. To access the health-check system 405 via the API 415, users may access the management system 410 via designated devices such as laptops, desktops, tablets, mobile devices, other handheld or portable devices, and/or other types of computing devices that are configured to access the API. These devices may be different from the device on which the health-check system 405 is installed.

In some embodiments and when the management system 410 is configured for use via the API 415, the users may access the health-check system 405 via a web browser and upon entering a uniform resource locator (“URL”) for the API. Using the API 415, the users may then send instructions to the health-check system 405 and receive information back from the health-check system. In some embodiments, the API 415 may be a representational state transfer (“REST”) type of API. In other embodiments, the API 415 may be any other type of web or other type of API (e.g., ASP.NET) built using any of a variety of technologies, such as Java, .Net, etc., that is capable of accessing the health-check system 405 and facilitating communication between the users and the health-check system.

In some embodiments, the API 415 may be configured to facilitate communication between the users via the management system 410 and the health-check system 405 via a hypertext transfer protocol (“HTTP”) or hypertext transfer protocol secure (“HTTPS”) type request. The API 415 may receive an HTTP/HTTPS request and send an HTTP/HTTPS response back. In other embodiments, the API 415 may be configured to facilitate communication between the management system 410 and the health-check system 405 using other or additional types of communication protocols.

In other embodiments, instead of or in addition to being installed on a particular device as discussed above, the management system 410 may be hosted on a cloud service and may be accessed via the cloud using the API 415 or other mechanism. In some embodiments, the management system 410 may additionally or alternatively be configured as a mobile application that is suitable for installing on and access from a mobile computing device (e.g., a mobile phone). In other embodiments, the management system 410 may be configured for user access in other ways.

Thus, the management system 410 provides a user interface that facilitates human-computer interaction between the users and the health-check system 405. Thus, the management system 410 is configured to receive user inputs from the users via a graphical user interface (“GUI”) of the management system and transmit those user inputs to the health-check system 405. The management system 410 is also configured to receive outputs/information from the health-check system 405 and present those outputs/information to the users via the GUI of the management system. The GUI may present a variety of graphical icons, visual indicators, menus, visual widgets, and other indicia to facilitate user interaction. In other embodiments, the management system 410 may be configured as other types of user interfaces, including for example, text-based user interfaces and other man-machine interfaces. Thus, the management system 410 may be configured in a variety of ways.

Further, the management system 410 may be configured to receive user inputs in a variety of ways. For example, the management system 410 may be configured to receive the user inputs using input technologies including, but not limited to, a keyboard, a stylus and/or touch screen, a mouse, a track ball, a keypad, a microphone, voice recognition, motion recognition, remote controllers, input ports, one or more buttons, dials, joysticks, etc. that allow an external source, such as the user, to enter information into the management system. The management system 410 may also be configured to present outputs/information to the users in a variety of ways. For example, the management system 410 may be configured to present information to external systems such as users, memory, printers, speakers, etc.

Therefore, although not shown, the management system 410 may be associated with a variety of hardware, software, firmware components, or combinations thereof. Generally speaking, the management system 410 may be associated with any type of hardware, software, and/or firmware component that enables the health-check system 405 to perform the functions described herein and further enables a user to manage and operate the health-check system.

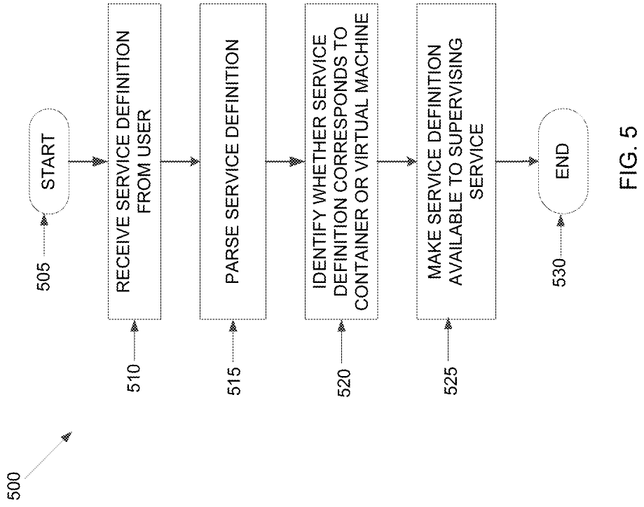

Turning now to FIG. 5, an example flow chart outlining operations of a process 500 are shown, in accordance with some embodiments of the present disclosure. The process 500 may include additional, fewer, or different operations, depending on the particular embodiment. The process 500 is discussed in conjunction with FIGS. 3 and 4, and is implemented by the health-check system 405, and particularly by the task dispatcher 420 of the health-check system. The process 500 starts at operation 505 with the task dispatcher 420 sending and presenting the service definition template to the user via the management system 410. As indicated above, the task dispatcher 420 may send the service definition template to the user upon receiving a request from the user via the management system 410, upon creating a new instance of a container (e.g., the containers 305, 310), a new instance of a virtual machine (e.g., the virtual machines 315, 320), installing a new application (e.g., the applications 335, 340, 370, and 375), periodically to update the service definition, and/or based upon satisfaction of other conditions programmed within the task dispatcher.

At operation 510, the task dispatcher 420 receives the completed service definition template back from the user via the management system 410. The task dispatcher 420 may save the completed service definition template within the memory 425. Additionally, at operation 515, the task dispatcher 420 parses the information within the service definition template. As indicated above, the totality of information within the service definition template constitutes the service definition. Thus, the task dispatcher 420 parses the service definition. As part of parsing the service definition, at operation 520, the task dispatcher 420 identifies whether the service definition applies to a container (e.g., the containers 305, 310) or a virtual machine (e.g., the virtual machines 315, 320). The task dispatcher 420 may also identify whether the service definition applies to a specific one or more applications (e.g., the applications 335, 340, 370, and 375), the operating parameters to monitor, what constitutes violation of those operating parameters (e.g., thresholds), and any additional information that the supervising service 430 may need to perform a health-check. The task dispatcher 420 may also save the parsed service definition within the memory 425 at operation 525, and make the parsed service definition available to the supervising service 430 for performing a health-check. The process 500 ends at operation 530.

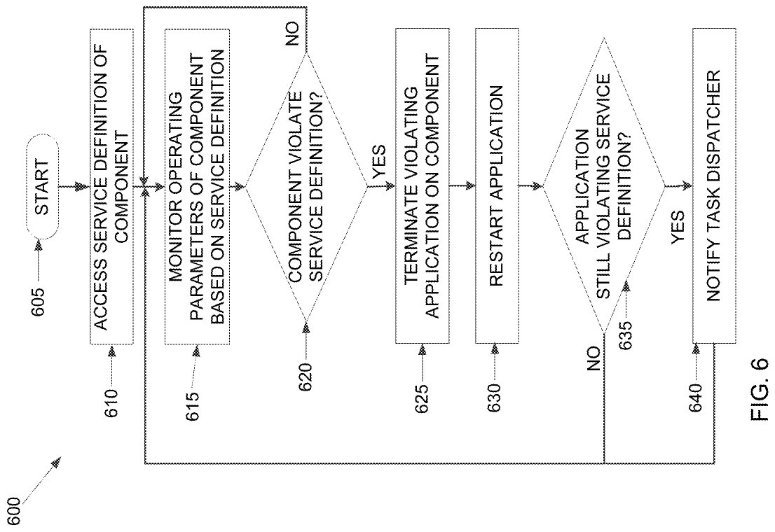

Turning now to FIG. 6, an example flowchart outlining operations of a process 600 is shown, in accordance with some embodiments of the present disclosure. The process 600 may include additional, fewer, or different operations, depending on the particular embodiment. The process 600 is discussed in conjunction with FIGS. 3-5 and is implemented by the health-check system 405, and particularly by the supervising service 430 of the health-check system. The process 600 starts at operation 605 and, at operation 610 the supervising service 430 accesses the service definition parsed by the task dispatcher in the process 500.

In some embodiments, the supervising service 430 may receive the parsed service definition directly from the task dispatcher 420. In other embodiments, the supervising service 430 may retrieve the parsed service definition from the memory 425. Upon retrieving the parsed service definition, the supervising service may identify from the parsed service definition whether the service definition corresponds to a virtual machine or a container. The supervising service 430 may also identify from the parsed service definition the frequency with which to perform the health-check. For example, in some embodiments, the service definition may indicate that the health-check is to be run every second, every pre-determined number of seconds or fractions of seconds, once a day, once every few hours, or in any other units of time. In some embodiments, the supervising service 430 may receive instructions from the user (either directly or via the task dispatcher 420) to run a health-check on-demand, and in response, the supervising service 430 may run the health-check regardless of the frequency indicated in the service definition. In yet other embodiments, the service definition may indicate that the supervising service 430 is to continually monitor the component being health-checked and continually run a health-check thereon as new values of the operating parameters become available. As used herein, a “health-check” means monitoring the operating parameters of the component being health-checked and determining from those operating parameters whether the values are in compliance with the thresholds or definitions of those operating parameters included in the service definition, as further discussed below.

The supervising service 430 may also identify additional information from the parsed service definition. For example, the supervising service 430 may determine the identity of the virtual machine or container on which the health-check is to be run, identity of any specific applications on the virtual machine or container to be monitored, the operating parameters to be monitored, values or thresholds of the operating parameters indicative of service definition violation, and any other information that the supervising service may need to perform an effective health-check. For example, if the supervising service 430 determines that the service definition corresponds to running a health-check on a virtual machine (e.g., the virtual machine 315) and more specifically on an application (e.g., the application 370) within that virtual machine, the supervising service may determine the specific parameters of the application to monitor, and the values of those parameters that would cause the application to violate the service definition.

To perform a health-check, at operation 615, the supervising service 430 monitors the operating parameters of the component identified from the service definition. For example and continuing with the example above, say the parameters to be monitored for the application 370 as stated in the service definition include processing latency and active memory consumed. The supervising service 430 then monitors the processing latency and active memory consumption of the application 370. The frequency with which the supervising service 430 monitors the processing latency and active memory consumption may be the same frequency from the service definition within which to perform health-checks. Thus, in some embodiments, the supervising service 430 may monitor for any updates since the last health-check to the processing latency and active memory consumption when the supervising service is ready to perform a health-check. In other embodiments, the supervising service 430 may monitor and retrieve the values of processing latency and active memory consumption at a first time period and run the health-check at a second time-period based on the frequency mentioned in the service definition. Thus, the relative timing of monitoring the operating parameters and running a health-check based on those operating parameters may vary from one embodiment to another.

As part of monitoring the operating parameters (e.g., the processing latency and active memory consumption parameters), the supervising service 430 collects actual values of those operating parameters related to the component being monitored (e.g., from the application 370 of the virtual machine 315). In some embodiments, the supervising service 430 may collect the actual values of the operating parameters via an API. The API may provide an interface with a set of routines, protocols, and tools to allow the supervising service 430 to access and collect the actual values of the operating parameters. For example, in some embodiments, to collect such parameter related information, the supervising service 430 may establish communication with the API, which in turn may access the appropriate elements (operating system counters, other counters, logs, etc.) that collect the operating parameter related information. The API may extract the operating parameter related information from those elements and return the collected information to the supervising service 430. In some embodiments, the supervising service 430 may use mechanisms other than an API to collect the operating parameter related information.

Upon receiving the operating parameter related information, the supervising service 430 may at least temporarily store the operating parameter related information within the memory 425. Further, at operation 620, the supervising service 430 runs a health-check by determining whether any of the operating parameter related information collected at the operation 615 violates the service definition. In the example above, the supervising service 430 may determine whether the processing latency and/or the active memory consumption violate the service definition. As indicated above, the service definition may define what constitutes a violation or at least include the expected normal values of the operating parameters being monitored. Thus, the supervising service 430 compares the actual values of the operating parameters collected at the operation 615 with the values indicated in the service definition and determine whether a violation has occurred. For example, if the actual value of processing latency collected from the operation 615 is two seconds, and the service definition indicates that the expected normal processing latency is one second (or that a processing latency greater than one second is a violation), the supervising service may determine that the application (e.g., the application 370) has violated the service definition since the actual processing latency value of two seconds is greater than the expected normal value of one second.

Similarly for each operating parameter being monitored, the supervising service 430 determines whether that operating parameter is in violation of the service definition. Upon finding that at least one of the operating parameters being monitored is in violation of the service definition, the process 600 proceeds to operation 625. On the other hand, if the supervising service determines that none of the operating parameters being monitored violate the service definition, the process 600 returns to the operation 615 to continue to monitor the operating parameters and collect their actual values.

At the operation 625, upon determining a violation, the supervising service 430 attempts to troubleshoot the violation. For example, the supervising service 430 may terminate the application (e.g., the application 370) and restart the application at operation 630 in attempt to fix the violation. Upon restarting at the operation 630, the supervising service 430 may collect actual values of the violating operating parameter again and recheck for the violation at operation 635. If the supervising service 430 determines that the application is still violating the service definition, the supervising service may attempt to terminate the application and restart the application at the operations 625 and 630, respectively, a predetermined number of times or trials. Upon failing to fix the violation after the pre-determined number of times or trials, the supervising service 430 alerts the task dispatcher 420 at operation 640 and returns to monitoring the application at the operation 615.

On the other hand, if at the operation 635, the supervising service 430 determines that upon terminating the application, restarting the application, and rechecking for violations in the pre-determined number of times or trials has indeed fixed the violation, the supervising service returns to the operation 615. Although the troubleshooting operation described herein that is performed at the operations 625 and 630 is terminating and restarting an application, in other embodiments, other actions may be taken. For example, in some embodiments, the supervising service 430 may temporarily stop the operation of the virtual machine (e.g., the virtual machine 315) (or the container if a container is being monitored) and restart the virtual machine or container. In other embodiments, the supervising service 430 may communicate with a separate troubleshooting utility that may attempt to identify the specific cause of the violation (e.g., why is the processing latency greater than the normal value) and take one or more troubleshooting actions based on the identified cause. Similarly, the supervising service 430 may be programmed to take other corrective action.

If the service definition does not identify a specific application on the container (e.g., the container 305, 310) or virtual machine (e.g., the virtual machine 315, 320) being monitored, upon finding a violation, the supervising service 430 may temporarily terminate and restart the container or virtual machine. In some embodiments, the supervising service 430 may identify the specific application causing the violation even though the application may not have been mentioned in the service definition and perform the operations 625 and 630 on the application.

In some embodiments, the supervising service 430 may also create a record of the violation and store the record within the memory 425 and/or make available to the user via the management system 410. Further, to alert the task dispatcher 420 at the operation 640, the supervising service 430 may, in some embodiments, create a notification identifying the component (e.g., the virtual machine 315 and specifically the application 370 thereon) that is in violation, the operating parameter of the component that is in violation, values of the operating parameter causing the violation, and any other information that is desired or considered needed.

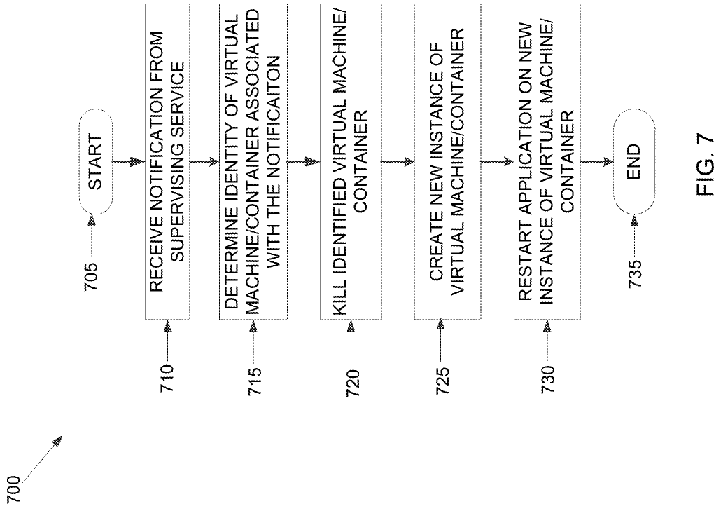

Upon receiving the alert from the supervising service 430 at the operation 640, the task dispatcher performs a process 700 of FIG. 7. Thus, turning to FIG. 7, an example flowchart outlining operations of the process 700 is shown, in accordance with some embodiments of the present disclosure. The process 700 may include additional, fewer, or different operations, depending on the particular embodiment. The process 700 is discussed in conjunction with FIGS. 3-6 and is implemented by the health-check system 405, and particularly the task dispatcher 420 of the health-check system. The process 700 starts at operation 705 and at operation 710, the task dispatcher 420 receives the alert from the operation 640 sent by the supervising service 430. Thus, the process 700 is implemented when temporary fixes to resolve the violation by the supervising service 430 are not successful.

At operation 715, the task dispatcher 420 determines from the notification the identity of the component that is in violation. The task dispatcher 420 may also identify any other information from the notification or any other source any additional information that is needed or desirable for the task dispatcher to have in resolving the violation. Since the temporary fixes applied by the supervising service 430 in the process 600 did not work, the task dispatcher 420 may apply more aggressive fixes. For example, at operation 720, the task dispatcher 420 may kill the virtual machine or container on which the violation was detected. Thus, even though the violation may be attributed to a specific application (e.g., the application 370) on the virtual machine or container, the task dispatcher 420 may terminate the underlying virtual machine or container. To kill a virtual machine or container, the task dispatcher 420 may (or the task executor 435 upon receiving instructions from the task dispatcher may) power off the associated virtual machine or container.

The task dispatcher 420 may also save the configuration settings of the virtual machine or container being killed. For example, the task dispatcher 420 may save the various memory, power, networking, processing capacity, etc. settings of the virtual machine or container being killed. At operation 725, the task dispatcher 420 may create a new instance of the killed virtual machine or container on the same underlying node or on a different node within the cluster. The task dispatcher 420 may use the saved settings of the killed virtual machine or container to create the new instance of the virtual machine or container. Additionally, the task dispatcher 420 restarts the application(s) running on the killed virtual machine or container on the newly created instance of the virtual machine or container at operation 730. In other embodiments, the task dispatcher 420 may be programmed to other corrective actions.

Additionally, the task dispatcher 420 may update the service definition associated with the killed virtual machine or container. In some embodiments, the task dispatcher 420 may update the identity of the virtual machine or container from the killed virtual machine or container to the newly created instance. The task dispatcher 420 may also notify the user of the new instance of the virtual machine or container and request any updates to the service definition that the user may want to make. The process 700 ends at operation 735.

Thus, the present disclosure provides a mechanism to automatically, effectively, and efficiently monitor both virtual machines and containers with a single utility and maintain a desired state of the system. It is to be understood that any examples used herein are simply for purposes of explanation and are not intended to be limiting in any way.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
collecting, by a processor, an operating value of a parameter associated with a virtual machine or a container;
determining, by the processor, a violation of a service definition based on the operating value; and
troubleshooting, by the processor health check system, the virtual machine or the container that is in violation upon finding the violation,
wherein the processor monitors both the virtual machine and the container based upon the service definition.

2. The method of claim 1, wherein the service definition identifies the parameter to be monitored by the processor and a threshold indicative of the violation of the parameter.

3. The method of claim 1, wherein the service definition identifies the virtual machine or the container to be monitored.

4. The method of claim 2, further comprising comparing, by the processor, the operating value of the parameter with the threshold of the corresponding parameter for determining the violation.

5. The method of claim 1, wherein the processor restarts the virtual machine or the container that is in violation.

6. The method of claim 1, further comprising
determining, by the processor, that the virtual machine or the container that is in violation is in compliance with the service definition after the troubleshooting.

7. The method of claim 1, further comprising
terminating, by the processor, the virtual machine or the container that is in violation upon failing to bring the virtual machine or the container that is in violation in compliance with the service definition after troubleshooting a predetermined number of times.

8. The method of claim 7, further comprising updating the service definition upon creating a new instance of the virtual machine or the container that is terminated.

9. An apparatus having programmed instructions that cause a processor to:
collect an operating value of a parameter associated with a virtual machine or a container;
determine that the virtual machine or the container is in violation of a service definition based on the operating value; and
troubleshoot the virtual machine or the container that is in violation upon finding the violation,
wherein the processor monitors both the virtual machine and the container based upon the service definition.

10. (canceled)

11. The apparatus of claim 9, wherein the processor receives the service definition from a user.

12. The apparatus of claim 9, wherein the processor terminates the virtual machine or the container that is in violation upon failing to resolve the violation in a pre-determined number of trials; and
creates a new instance of the virtual machine or the container that has been terminated to resolve the violation.

13. The apparatus of claim 12, wherein, upon finding the violation, the processor restarts the virtual machine or the container that is in violation in attempt to resolve the violation before terminating that virtual machine or the container.

14. The apparatus of claim 9, wherein the processor identifies the violation based on the operating value of the parameter exceeding a threshold included in the service definition.

15. The apparatus of claim 9, wherein the processor checks for violations periodically based on a frequency included in the service definition.

16. The apparatus of claim 9, wherein the processor identifies the parameter from the service definition.

17. A non-transitory computer readable media with computer-executable instructions embodied thereon that, when executed by a processor, cause the processor to perform a process comprising:
collecting an operating value of a parameter associated with a virtual machine or a container;
determining a violation of a service definition based on the operating value of the parameter exceeding a threshold identified from the service definition; and
troubleshooting the virtual machine or the container that is in violation upon finding the violation,
wherein the processor monitors both the virtual machine and the container based upon the service definition.

18. The non-transitory computer readable media of claim 17, wherein the processor performs at least one troubleshooting action to resolve the violation.

19. The non-transitory computer readable media of claim 17, wherein the processor terminates the virtual machine or the container that is in violation after performing the troubleshooting a predetermined number of times and failing to resolve the violation.

20. The non-transitory computer readable media of claim 19, wherein the processor creates a new instance of the virtual machine or the container that is terminated for resolving the violation.

21. The method of claim 1, further comprising determining, by the processor, that the virtual machine or the container that is in violation is not in compliance with the service definition after the troubleshooting.

22. The method of claim 21, further comprising performing, by the processor, at least one additional troubleshooting action for bringing the virtual machine or the container that is in violation in compliance with the service definition.

23. The method of claim 7, further comprising creating, by the processor, a new instance of the terminated one of the virtual machine or the container.

24. The apparatus of claim 12, wherein the processor updates the service definition with the new instance of the virtual machine or the container.
